(19) United States
(12) Patent Application Publication
(10) Pub. No.: US 2005/0063712 A1
(43) Pub. Date: Mar. 24, 2005

(54) High speed large core multimode fiber optic transmission system and method therefore

(76) Inventors: Robert R. Rice, Simi Valley, CA (US); Petras V. Avizonis, Laguna Hills, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/668,818

(22) Filed: Sep. 22, 2003

(51) Int. Cl. H04B 10/04

(52) U.S. Cl. 398/200

(57) ABSTRACT

Methods and apparatus are provided for a system for high speed data transmission. The apparatus is a light source for transmitting data, a large core multimode fiber optic cable, and a lens. The fiber optic cable has a core with a diameter greater than 50 microns. The lens has a focal length f and is placed a distance f from an exposed end of the fiber optic cable. A light signal from the lens has a diameter approximately equal to the diameter of the core to reduce higher order modes excited in the fiber optic cable thereby increasing a length/data rate product. The method increases a length/data rate product of a large core multimode fiber optic cable. Light signals are launched to the fiber optic cable to promote lower order modes and reduce higher order modes. Higher order modes are attenuated as the light signals travel through the fiber optic cable.

### TECHNICAL FIELD OF THE INVENTION

The present invention generally relates to fiber optics, and more particularly relates to a fiber optic system for transmitting at high speeds on a large core fiber optic cable.

### BACKGROUND OF THE INVENTION

In general, fiber optic cable acts as a pathway for light. In simple terms, light is introduced to a fiber optic cable at one end by a transmitter and the light is received at the other end by a receiver. The transmitter input signal may be in the form of an electrical signal that is converted to a light signal. Similarly, the receiver may convert the light signal back to an electrical signal for components on the receiving end. The high speed at which light travels makes fiber optic cable an ideal medium for transmitting digital signals. The transmitted light signal does attenuate as it travels through the fiber optic. Repeaters are required before the light signal is attenuated to a level where the integrity of the transmission is compromised. A repeater amplifies or conditions the light signal to original levels. How often repeaters are required is a significant factor in the choice of fiber optic system used. For the case of digital transmission, the two logic states are generated by the conditions when light is detected or when light is not detected. Although the basic concept is not difficult to understand, the implementation of a high speed network is very challenging. For example, there are limits on the speed at which data can be transferred using existing fiber optic systems.

A fiber optic cable is a strand of glass. The cable must be of extremely high quality glass having no defects or impurities. Impurities in the glass absorb light which degrades and attenuates the light signal being transmitted. In general, a core of a fiber optic cable is made from extremely pure silica, which reduces attenuation thus enabling a longer cable to be used before a repeater is required. A layer of cladding is placed around the core. The cladding layer is designed having a lower refractive index than the core material. The light transmitted in the core will remain within the core because the light signal reflects off of the cladding. Reflection of the transmitted light will occur as long as the light strikes the core/cladding interface at an angle greater than the critical angle that is defined by the materials used in the fiber optic cable.

One type of fiber optic cable is a single mode cable. Typically, single mode cable has a small diameter in the range of 10 microns or less for wavelengths in the 850-1500 nanometer range. The small diameter of the single mode cable is selected to allow only a single mode of light to travel through the fiber, while higher order modes are not supported by the small diameter fiber core. A light source having a narrow spectral width is used with single mode cable. Currently, the advantages of single mode cable are greater transmission lengths and higher data transmission rates. The fact that single mode cable passes a single light-wave greatly reduces distortion of the transmitted waveform thereby resulting in longer transmitted distances and higher transmission speeds. The negatives of single mode cable are cost and the complexity of the components required to align, splice, and connect a fiber optic cable having a diameter of 10 microns or less. Still, single mode fiber optic cable is capable of transmission 50 times the distance of other types of fiber optic cable and at higher transmission rates. Single mode fiber optic cable is still the choice for long distance fiber optic cable routing.

Another type of fiber optic cable is a large core multimode cable. The large core multimode cable typically has a core size on the order of or greater than 50 microns. Common sizes for a large core multimode cable are 50, 62.5, and 100 micron diameters. In general, the preferred light source for transmission in a large core multimode cable is 850 and 1300 nanometers. As its name implies, large core multimode cable allows light waves to be dispersed into numerous paths or modes that travel down the cable core. The multiple modes travel at different phase velocities and hence produce waveform distortion and noise at the receiving end. The distortion becomes a significant issue for greater distances, and thus multimode cable has been found not to be suitable for long distance applications. The multiple modes also reduce the speed at which data can be transmitted.

Accordingly, it is desirable to increase the speed that data can be transmitted in a large core multimode cable. In addition, it is desirable to be able to extend the distance in which large core cable can be reliably used. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

An apparatus is provided for high speed data transmission. The apparatus comprises a light source for transmitting data, a large core multimode fiber optic cable, and a lens. The large core multimode fiber optic cable has a core with a diameter greater than 50 microns. The lens has a focal length f and is placed a distance f from an exposed end of the large core multimode fiber optic cable. A light signal from the lens has a diameter approximately equal to the diameter of the core to reduce higher order modes excited in the fiber optic cable thereby increasing a length/data rate product. A method is provided for increasing the length/data rate product for large core multimode fiber optic cable. The method comprises light signals that are launched to the fiber optic cable to promote lower order modes and reduce higher order modes. Higher order modes are preferentially attenuated as the light signals travel through the fiber optic cable.

### BRIEF DESCRIPTION OF THE DRAWINGS

The present invention will hereinafter be described in conjunction with the following drawing figures, wherein like numerals denote like elements, and

FIG. 1.is an illustration of pulse spreading in a large core multimode fiber optic cable;

FIG. 2 is an illustration of a large core multimode fiber optic cable in accordance with the present invention;

FIG. 3 is an illustration of a system for high speed optical data transmission in accordance with the present invention;

FIG. 4 is a graph of the test data using 850 nanometer light in accordance with the present invention; and

FIG. 5 is a graph of the test data using 1300 nanometer light in accordance with the present invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The cost and complexity of using single mode fiber optic cable is a significant factor in many business decisions. Single mode fiber optic cable is still the primary fiber optic of choice for extremely high speeds or where the cable is extended over a long distance. A large number of fiber optic applications fall in the low to medium distance range. An upper end of this range is approximately a 1 kilometer connection. Local area networks for business or home connections for a digital cable company are two well know high volume applications for fiber optic cable. Another application is related to the aerospace industry. Open avionics architectures are being developed for future aerospace programs that require links to airborne platforms or space craft requiring high speed data transfer. Typically, networks of this type have many connections, each capable of using a substantial amount of the available bandwidth. Single mode fiber optic cable is non-ideal for this application, because of its high cost and complexity of the components required. Moreover, the wavelength dispersion of single mode fiber is much larger than the wavelength dispersion for the lowest order modes of a multimode fiber; thus, in the limit it cannot provide the bandwidth of a system capable of operating with multiple modes.

Large core multimode fiber optic cable is an alternative to single mode fiber optic cable for low to midrange distances. Currently, large core multimode fiber optic cables are performance limited in length/data rate product. This will be discussed in more detail hereinbelow. In general, a core diameter of a large core multimode fiber optic cable is greater than 50 microns whereas a single mode core is typically 10 microns or less. In conventional systems, an upper limit for the data transfer rate of a large core multimode fiber optic cable is in the range of 1-10 gigabit per second and it is useful for applications less than 1000 meters in length without repeaters that regenerate the signal. The wavelength of light used for data transmission in a large core multimode fiber optic cable is typically greater than 750 nanometers.

Increasing the length/data rate product of large core multimode fiber optic cable would greatly enhance usage for low to middle distance applications because higher bandwidth and lower cost would be a driver to create a new infrastructure or replace the current infrastructure that is performance limited. One problem associated with reducing the length/data rate product of large core multimode fiber optic cables is a phenomenon known as pulse spreading, which is equivalent to the waveform degradation described hereinabove.

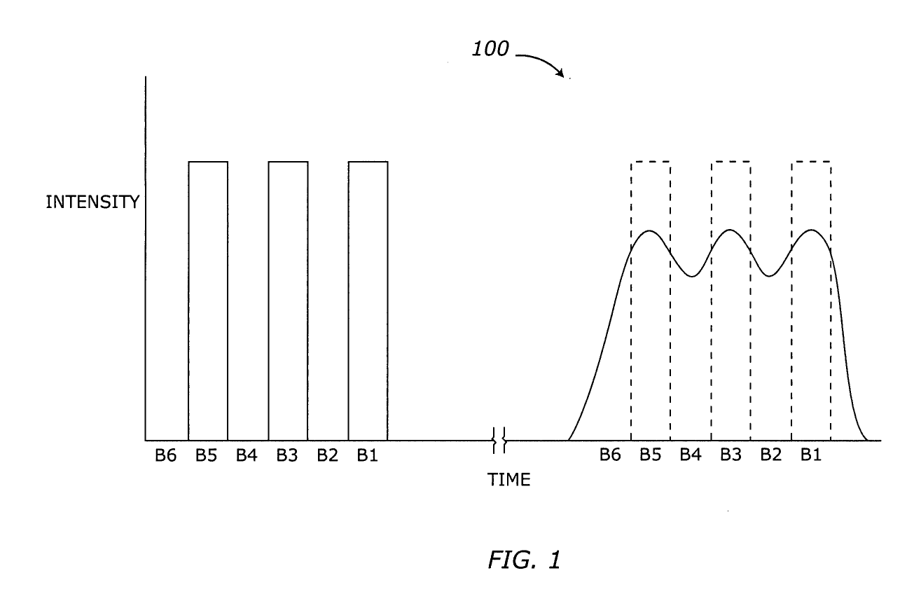

FIG. 1 is an illustration of pulse spreading in a large core multimode fiber optic cable. The Y-axis of the graph is light intensity while the X-axis is time. Three light pulses of equal intensity are shown. In total, six digital signals are represented by a 1, 0, 1, 0, 1, 0 data sequence that is identified as B1-B6. In this example, a logic 1 is represented by the presence of light and a logic zero by the absence of light. Thus, light pulses B1, B3, and B5 represent logic 1 levels. The absence of light during B2, B4, and B6 represent logic 0 levels. It should be noted that each light pulse or absence of light representing a logic level is an event that occurs for a predetermined time period. Each event (logic level) occurs over an equal time period. The time of each event (logic level) is inversely proportional to the speed. Thus, higher data transmission rates reduce the time of each event. Initially, when the data sequence is launched into the large core multimode fiber optic cable, light pulses B1, B3, and B5 have well defined shapes as shown. As the pulses travel down the fiber optic cable, each pulse (B1, B3, and B5) may lose their shape and begin to spread out. The intensity level of each light pulse is also reduced as the pulse spreading occurs. At some distance from the launch point, the light pulses (B1, B3, and B5) begin to merge with one another. The merging of the pulses produces a situation where, in the presence of background system and receiver noise, pulse spreading masks out the logic 0 levels (B2, B4, and B6). This is readily seen in merged pulse 100.

Pulse spreading occurs due to dispersion. A light pulse comprises many modes of light that travel at different rates along the fiber optic cable. The main component of pulse spreading in a large core multimode fiber optic cable is multimode dispersion. Lower order modes of the light pulse travel a shorter distance than higher order modes. The lower order modes tend to travel almost parallel to the center line of the fiber optic cable. The higher order modes tend to take a longer path reflecting off a cladding layer surrounding the core of the fiber optic cable. The cladding layer is designed to have a lower refractive index than the core glass. The lower refractive index of the cladding layer reflects the higher order mode light thereby keeping it within the core. The light is retained as long as the light hits the core/cladding interface at an angle greater than a critical angle. The light traveling in low order modes are more completely contained within the fiber core and hence have propagation constants more nearly reflecting the refractive index of the core material alone. Chromatic dispersion is another factor in pulse spreading. Chromatic dispersion is the variation of refractive index with the wavelength of light. The net result of chromatic dispersion is that different wavelengths will travel at different speeds.

The total dispersion is the combination of multimode dispersion and chromatic dispersion. The total dispersion directly relates to the amount of pulse spreading that will occur. In other words, both multimode and chromatic dispersion affect the speed of travel which results in the modes reaching the end of the large core multimode fiber optic cable at different times. The effects of total dispersion are cumulative over distance in the fiber so that signals are more distorted the longer the propagation length. Conversely, the pulse would appear identical to the initial pulse sequence if the components of a light pulse were unaffected by the fiber optic cable.

Pulse spreading impacts the maximum frequency bandwidth that can be used to transmit information through the large core multimode fiber optic cable. A maximum frequency relates proportionally to the fastest speed at which data can be transmitted reliably and accurately. Above the maximum frequency bandwidth, pulse spreading merges the data or makes the detection of the signal prone to error. Similarly, since pulse spreading is proportional to fiber cable length, a maximum distance for a given frequency is the longest length of fiber optic cable that can be used for quality data transmission. Pulse spreading makes detection of the data unreliable above the maximum distance for the given frequency. A common measure of the performance of a fiber optic cable is the length/data rate product which is also known as the bandwidth/distance product (BDP).

One scheme that has been effectively used to extend the length/data rate product of a large core multimode fiber optic cable is to use a graded index core. A graded index core has a core where the refractive index decreases from the core center to the core interface with the cladding layer. The graded index core compensates for the different paths and path lengths that different modes of the light pulse take when traveling through a large core multimode fiber optic cable. Low order modes of a light pulse travel through a region of higher refractive index in the graded index core. The higher refractive index near the core center makes the low order modes travel at a slower velocity. The slower velocity compensates for the fact that the lower order modes travel the shortest effective distance. Conversely, higher order modes of the light pulse travel mostly in the region of the graded index multimode fiber optic cable away from the core center. In general, the higher order modes travel a greater effective distance reflecting off of the cladding layer as it travels back and forth down the fiber. The graded index core has a lower refractive index away from the core center. The lower refractive index allows the higher order modes to travel at a higher velocity to compensate for the longer travel distance.

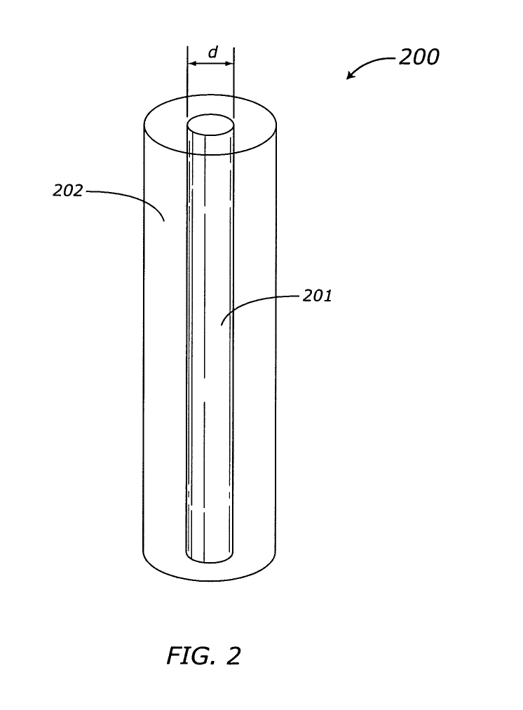

FIG. 2 is an illustration of a large core multimode fiber optic cable 200 in accordance with the present invention. Large core multimode fiber optic cable 200 comprises a core 201 and a cladding layer 202. Cladding layer 202 surrounds and retains light within core 201. Core 201 has a diameter d. Large core multimode fiber optic cable 200 typically has the diameter d greater than 50 microns although the principles described hereinbelow can be applied to cores less than 50 microns in diameter. Large core multimode fiber optic cable 200 operates at data rates in the 10-15 gigabits per second (Gbps) over moderate distances which cannot be achieved with existing prior art technology.

Pulsed light coupled to large core multimode fiber optic cable 200 excites many guided wave modes, each of which has a particular phase and amplitude distribution as well as its own specific propagation velocity. In general, modes are a solutions of Maxwell's wave equation that satisfy the boundary conditions, each forming a unique pattern of standing waves in a radial and azimuthal direction on the cross-section of the large core multimode fiber optic cable 200. Core 201 has a refractive index of n₁. Cladding layer 202 has a refractive index of n₂. In general, n₁ must be greater than n₂ for guided wave propagation. The Numerical Aperture (NA) for large core multimode fiber optic cable 200 is the sine of the input optical acceptance angle θₐ and is shown in equation 1.
NA=(n₁²−n₂²)^{1/2} Equation 1
Large core multimode fiber optic cable 200 can be described with respect to a parameter called the V number which corresponds to the normalized frequency. The V number is described by equation 2 where a constant α is the fiber core radius and λ₀ is wavelength.
V=(2πα/λ₀)NA Equation 2
Large core multimode fiber optic cable 200 will support a large number of modes that is expressed approximately as M as shown in equation 3.
M≅(4/π²)V² Equation 3
A mode is characterized by its propagation constant. The propagation constant is an Eigen value of Maxwell's wave equation. The propagation constants for large core multimode fiber optic cable 200 is expressed approximately as βₗₘ as shown in equation 4.
βₗₘ≅n₁k₀[1−(l+2m)²(n₁−n₂)/M] Equation 4
Mode indices: l=0, 1, . . . , (M)^{1/2}, m=1, 2, . . . , ((M)^{1/2}−l)/2 for V>>1.
   In general, M is a very large value for large core multimode fiber optic cable 200. An approximation of equation 4 for large values of M and small values of the mode indices l and m is shown in equation 5.
   βₗₘ≅n₁k₀ Equation 5
   How the light is launched into large core multimode fiber optic cable 200 will determine what modes are excited and to what degree they are excited. For example, input cone angle, spot size, and axial centration are all controllable parameters of the launch. In an embodiment of the high speed optical data transmission system, an input light signal is launched to large core multimode fiber optic cable 200 to excite low order modes. The consequence of launching the power in low order modes for multimode fiber optic cable 200 is that a short pulse will propagate for a long distance with only minimal pulse spreading since the higher order modes are significant contributors to the spreading because of the longer distance they travel. Thus, the intersymbol interference (ISI) produced when a pulse representing a binary “1” spreads into an adjacent time slot that contains no pulse, (i.e. a binary 0), is extended to much higher frequencies. For example, it is expected that 10-15 gigabit per second rates are achievable for midrange distances less than 1 kilometer. A further benefit in reducing pulse spreading in large core multimode fiber optic cable 200 is achieved by modifying cladding layer 202 to attenuate higher order modes. The attenuation of higher order modes is discussed in further detail hereinbelow.

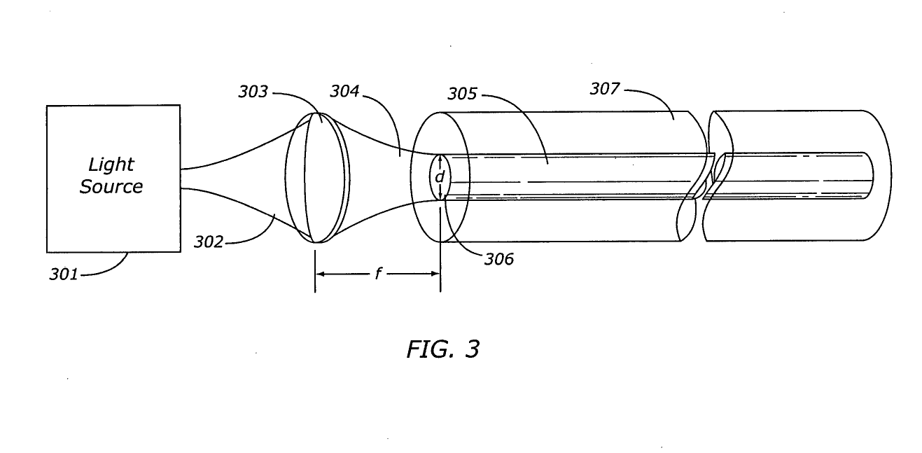

FIG. 3 is an illustration of a system 300 for high speed optical data transmission in accordance with the present invention. System 300 comprises a light source 301, a lens 303, and a large core multimode fiber optic cable 305. In general, large core multimode fiber optic cable 305 has a core 306 having a diameter d that is typically greater than 50 microns. In an embodiment of the high speed optical data transmission system a diode laser or a light emitting diode (LED) is used as light source 301. Light source 301 provides light having a wavelength greater than 750 nanometers. A light signal 302 is launched from light source 301 to lens 303. Lens 303 collimates and focuses light signal 302 to launch mostly lower order modes into large core multimode fiber optic cable 305. In an embodiment of system 300, lens 303 has a high numerical aperture for collimating, for example a numerical aperture of 0.5.

A diode laser or LED emitting an irregular train of short optical pulses representing “1”s and “0”s will radiate into a large cone of light if the beam is allowed to expand freely. Lens 303 has a focal length f. Lens 303 focuses light upon core 306 of large core multimode fiber optic cable 305. Light signal 302 is collimated by lens 303 and focused having a diameter substantially equal to the core diameter d of large core multimode fiber optic cable 305 when placed a distance f from core 306. The output from lens 303 is a collimated and focused light signal 304. Collimated and focused light signal 304 is injected into the core of large core multimode fiber optic cable 305 and excites a minimal number of fiber modes, that is, modes with low values for L and P) are produced. Hence, under these conditions the length/data rate product for large core multimode fiber optic cable 305 is maximized.

Through experimentation it has been found that the length/data rate product is enhanced by selectively attenuating higher order modes without affecting the lower order modes that preferentially travel through the most direct route which is the center of core 306 of large core multimode fiber optic cable 305. In general, higher order modes in a multimode fiber optic cable attenuate faster than lower order modes. Thus, higher order modes are damped out of the optical signal as it propagates along the fiber optic cable. These higher order modes have significantly larger values of βₗₘ and contribute to the pulse spreading phenomenon or dispersion that defines the length/data rate product of large core multimode fiber optic cable 305. Large core multimode fiber optic cable 305 is modified to further attenuate the higher order modes thereby increasing the length/data rate product.

In an embodiment of system 300, the modal discrimination of large core multimode fiber optic cable 305 is enhanced to damp the higher order modes that contribute to pulse spreading. It is desirable in many fiber links of moderate range to launch an input signal at a high signal level. An example of a high signal level is an input signal measuring greater than 20 dBm. Launching with a high signal level greater than 20 dBm and having a receiving power requirement of −20 dBm would make a 40-50 dB propagation loss in large core multimode fiber optic cable 305 tolerable. A 20 dBm launching signal level would not be feasible in a single mode system because the well-known power dependent nonlinear effects would render the system inoperable. However, this is not the case for large core multimode fiber optic cable 305 where high signal levels can be launched. Moreover, if the net signal attenuation is in the range of several dB per kilometer through large core multimode fiber optic cable 305, high data rate links of many kilometers are achievable.

As mentioned previously, it is desirable to improve modal discrimination of large core multimode fiber optic cable 305 such that the damping of higher order modes reduces pulse spreading thereby increasing the length/data rate product. The impact of damping is best understood by describing the modal properties of large core multimode fiber optic cable 305. The radial modal field distribution in a step index fiber is given by equations 6 and 7.
U₁(r)=J₁(k_{T}r) r<α (in the core) Equation 6
U₁(r)=K₁(γr) r>α (in the cladding) Equation 7
Thus, the radial modal field is represented by a Bessel function of a first kind of order 1 within the core of the step index fiber and by a modified Bessel function of a second kind of order 1 outside the core. The values for k_{T} and γ are quantities that are determined by matching boundary conditions at the interface of the core and cladding of the step index fiber. A relationship involving k_{T} and γ is described in equation 8.
k_{T}²+γ²=NA²k₀² where k₀ is 2π/λ₀ Equation 8
The relationship indicated in equation 8 shows that if k_{T} increases then the value of γ must decrease. It can also be shown that the form for K₁(γr) has an asymptotic form that is given by equation 9.
K₁(γr)≅(π/2γr)^{1/2} (1+(41²−1)/8γr)exp(−γr) Equation 9
First, the smaller the value of γ, the slower the value of K₁(γr) decays in the cladding. In other words, more of the modal field is contained in the cladding of the step index fiber. Second, as the value of 1 is increased (i.e. modes of higher order), the amplitude of the field in the cladding also increases rapidly. Thus, more of the field resides in the cladding as the mode order increases. As mentioned previously, the approximate propagation constants βₗₘ of the modes of a fiber with a large V parameter as a function of the mode indices l and m range from n₁k₀ for the lowest order modes to approximately n₂k₀ for modes near cutoff. A general definition of the propagation constant β is shown in equation 10.
β=(nᵣ+jnᵢ)k₀≅β₀+jε where ε is an attenuation constant Equation 10
This shows that if the refractive index is complex (i.e. the fiber exhibits a loss due to absorption or other dissipative process) the propagation constant is also complex. A small imaginary component can be characterized as β₀ obtained as nk₀ and the attenuation constant ε describes the decay of a wave as it propagates along the fiber. The lower order modes large core multimode fiber 305 will propagate with very low loss if the index of the core layer n₁ is primarily real (has a very low absorption coefficient). A modulated signal comprising lower order modes can propagate for long distances with reduced pulse spreading since the dispersion produced by the lower order modes is less than that contributed by the higher order modes. In general, a length/data rate product of large core multimode fiber optic cable 305 is increased by incorporating absorption loss such that the refractive index of a cladding layer 307 is complex. Increasing absorption loss in cladding layer 307 corresponds to increasing the value of εₗₘ as the mode order increases up to the cutoff of (M)^{1/2}. An example of a methodology to incorporate absorption loss is to dope cladding layer 307 with an absorptive material. Since very little of the low order modes exist in cladding layer 307, such modes will only be minimally impacted by the absorptive material. At the same time substantial amounts of high order modes exist in the cladding, and consequently undergo significant attenuations. The absorptive material to dope cladding layer 307 is selected to minimize attenuation of lower order modes while sharply attenuating higher order modes most responsible for pulse spreading effects that limit the length/data rate product of large core multimode fiber optic cable 305. The modal propagation losses can be estimated by calculating βₗₘ. A term Δ is calculated for cladding layer 307 having a complex refractive index (n₂ᵣ+jn₂ᵢ) as shown in equation 11.
Δ=(n₁−n₂)/n₁=(n₁−n₂ᵣ−jn₂ᵢ)/n₁=Δ₀−jn₂ᵢ/n₁ Equation 11
This can be substituted in the expression for βₗₘ to obtain a modified equation for a propagation constant that includes the effects of absorption in cladding layer 307. This is shown in equation 12.
βₗₘ≅n₁k₀[1−Δ₀(l+2m)/M+j(l+2m)²/Mn₁]=βₗₘ+jεₗₘ Equation 12
The real part of the mode propagation constant is substantially unaffected by small absorption levels in cladding layer 307, but there is now a mode order dependent loss term εₗₘ that results in increasing attenuation for higher order modes as shown in equation 13.
εₗₘ=k₀n₂ᵢ(l+2m)²/M Equation 13

An example shows the value of mode filtering for large core multimode fiber optic cable 305 having a cladding absorption coefficient ε₂ of 0.01/km, a core refractive index of 1.5, a wavelength of light of 850 nanometers, a core diameter of 100 microns, and a NA of 0.4. The numbers selected for the example hereinabove are for illustrative purposes and is achievable in a manufactured fiber. Large core multimode fiber optic cable 305 would support 35,266 (M) modes in this configuration. Calculating the mode order dependent loss term εₗₘ for a mode order of 100 and a mode order of 10 illustrates the difference in attenuation with higher order modes. The εₗₘ for a mode order of 100 is calculated as 0.00425/m (18.46 dB/km). The εₗₘ for a mode order of 10 is calculated as 0.0000425/m (0.0185 dB/km). Thus, it is readily seen that significant mode filtering effect occurs for an extended length, for example a 1 km length of fiber. The particular doping that is placed in cladding layer 307 is typically a rare earth ion that has some absorption at the wave length of interest. Thus, wavelength of operation will determine the specific doping ion for cladding layer 307. Different rare earth ions will have different absorption properties over the wavelength range of interest, for example wavelengths in the 800 to 1500 nanometer range.

What constitutes low order modes versus high order modes is determined by the specific parameters of the application. As shown in the calculations above, there is a substantial difference in the attenuation between mode order of 10 and mode order of 100. In general, a data transmission system is defined by many parameters of which two are data rate and the length of the longest (non repeater) cable run. One definition of what constitutes the higher order modes are the modes that need to be attenuated to meet the system requirement for length/data rate product. In particular, the modes being attenuated (higher order modes) contribute to pulse spreading that limits the length/data rate product. The modes that are not attenuated are the lower order modes, and their contribution to pulse spreading (dispersion) would be minimal.

A similar type of analysis can be performed for a graded index fiber with a corresponding result. The number of modes M is approximately half of what was calculated for a step index cable for the same core diameter and NA value. The mode order l+2m is replaced by a single index q for a graded index fiber analysis. The strategy to increase the length/data rate product of large core multimode fiber optic cable 305 as a graded index fiber is to attenuate higher order modes. Cladding layer 307 is doped to produce a small absorption level that selectively attenuates only higher order modes. The index profile of the graded index fiber is characterized by a parameter p which has a value of 2 for a simple quadratic index variation and a value of infinity for a step index fiber. The propagation constant for the q^{th} mode of the graded index variation under these herein listed conditions is described by equation 14.
β_{q}=n₁k₀[1−(q/M)^{p/(p+2)}Δ₀+j(q/M)^{p/(p+2)}n₂ᵢ/n₁]=β_{q0}+jε_{q} Equation 14
The mode order dependent loss term ε_{q} is represented by equation 15.
ε_{q}=k₀n₂(q/M)^{p/(p+2)} Equation 15
As mentioned previously, the most common form of graded index fiber has a p value equal to 2 so the attenuation coefficient increases by the square root of the mode order. It should be noted that this is a slower rate of change in attenuation as the mode order increases than is the case for a step index fiber. In either case, the step index fiber or the graded index fiber, the attenuation coefficient increases for higher order modes. For equal values of n₁, n₂, and α the ratio of the modal attenuation coefficients is given by equation 16.
ε_{qs}/ε_{qg}=q^{3/2}/V Equation 16
Thus, the mode filtering effect for higher mode orders is significantly better for step index fiber than for the graded index fiber.

Experiments were run to verify that the length/data rate product of a large core multimode fiber optic cable could be significantly enhanced by launching a light signal to propagate low order modes while attenuating the higher order modes that affect pulse spreading. Commercially available large core multimode cable having a 50 μm-core, 62.5 μm-core, and 100 μm-core were tested. Two different wavelengths (850 nm and 1300 nm) of light were used in the experiment to generate the light signal. The impact of connector loss and fiber attenuation was noted but was not the focus of the testing. In general, connector loss is connector dependent while fiber attenuation is a minor factor for midrange distances.

The testing monitored inter-symbol interference (ISI) that result in pulse spreading that degrades the bit error rate (BER) due to a reduction in signal-to-noise. The signal is attenuated as it travels down the fiber while the dominant receiver noise is independent of fiber loss therefore remaining constant. The chief source of dispersion in large core multimode fiber optic cable is due to modal dispersion. The signal components transmitted through the fiber arrive at the receiver at different times thus reducing the light pulse magnitude and spreading/smearing the light pulse. The testing takes advantage of the fact that dispersion is a linear function of fiber length for midrange distances.

The test system was capable of providing and measuring data rates up to 3 Gbps. The linear relationship between fiber length and dispersion is utilized to extrapolate performance for large core multimode cable operating at greater than 10 gigabits per second (Gps). For example, data transmitted at 3 Gbps over a fiber 1000 feet long will exhibit BER performance that approximates 10 Gbps data transmission over fiber 300 feet long or 15 Gbps data transmission over fiber 200 feet long. The cable used for testing were 1000 feet in length with no intermediate connections. The pattern used for the testing was a 2⁷−1 pseudorandom bit sequence (PRBS). Reference data was taken that determines performance without a cable under test. This is necessary because a link will naturally display reduced performance as the data rate is increased, due to reduced numbers of photons that exist per bit interval for increasing data rate, as well as due to diminished laser, laser driver, detector, and receiver amplifier performance at higher frequencies. Each setup included a variable attenuator in series with the transmitter. The attenuator is varied in increments of 1 dB with BER measured at each attenuation setting.

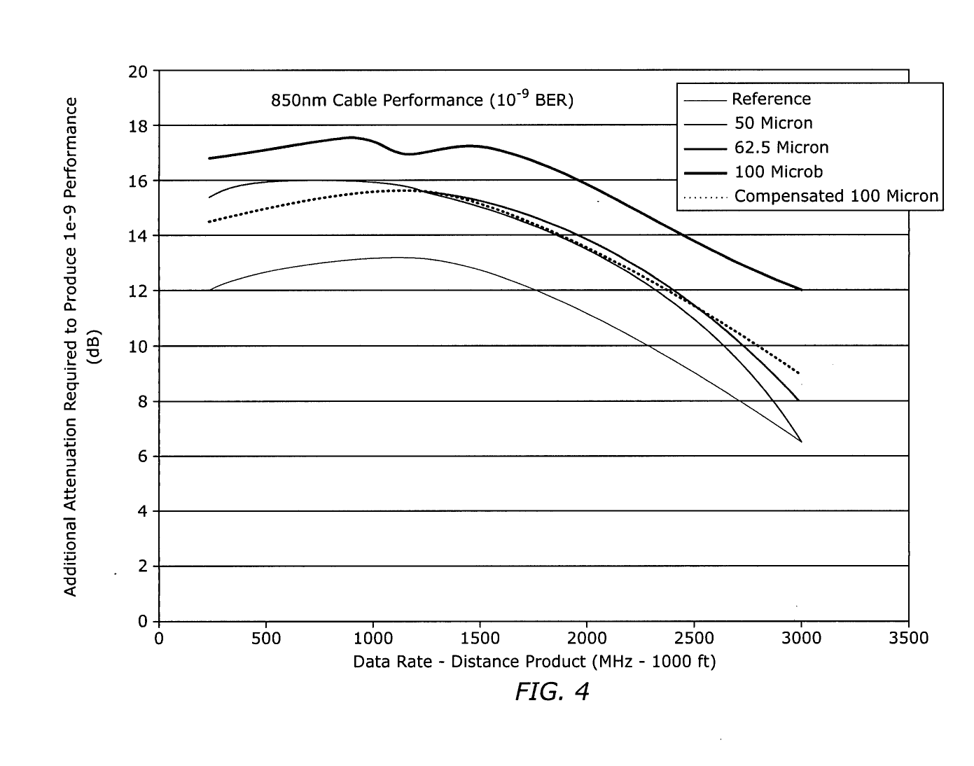

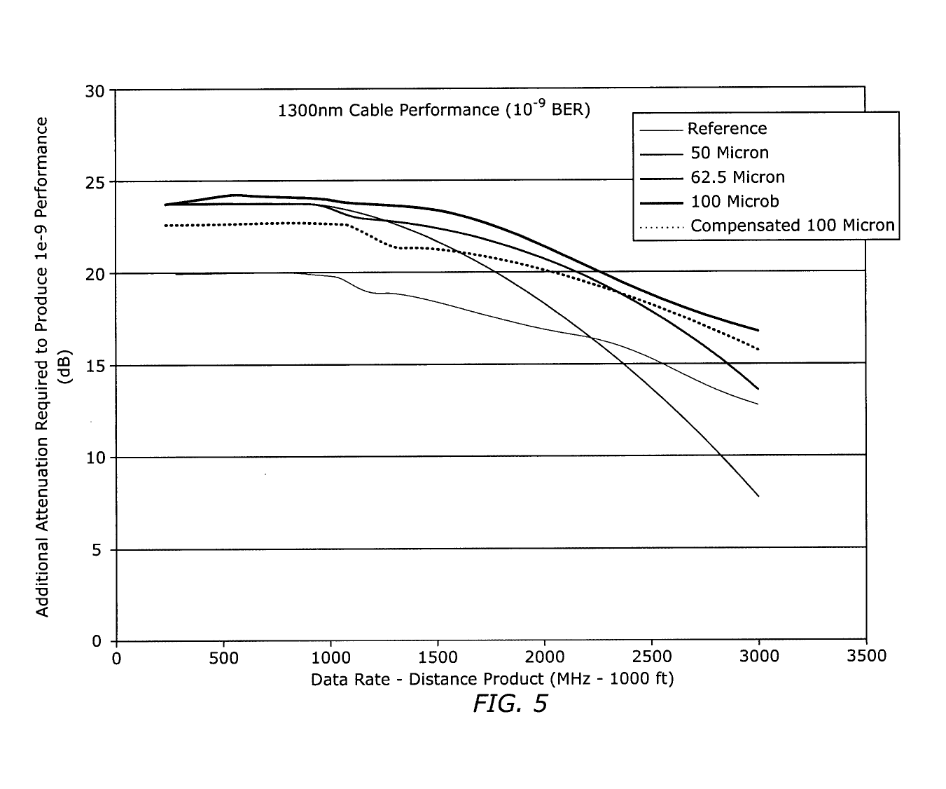

The testing provides proof that both initial launching of only lower order mode light and active attenuation of higher order modes contribute to increasing the length/data rate product of a large core multimode fiber optic cable. FIG. 4 is a graph of the test data using 850 nanometer light in accordance with the present invention. Data is presented for the reference (no fiber optic cable), 50 micron diameter core, 62.5 micron diameter core, and 100 micron diameter core. The fiber optic cable used to generate the data in both FIGS. 4 and 5 are graded index large core multimode fiber optic cable. The results show that the 100 micron diameter core fiber outperformed the 50 and 62.5 micron diameter core fibers. The trend to lower dispersion and improved ISI performance is evident as the droop in the 850 nm data decreases with increasing core diameter at roughly comparable attenuation. The substantially better performance at higher data rates is the result both of reduced modal dispersion in the lower order modes and the significantly higher attenuation which is serving to filter out the signal due to the dispersive higher order modes. One surprising result in the data for the 100 micron core fiber tracks the performance of the error rate test equipment at data rates up to the 3.5 Gbps limit. The implication of this testing is that signals at very high data rates could be propagated for midrange distances. Due to the limitations of the test system it is unclear exactly what the length/data rate product would be.

FIG. 5 is a graph of the test data using 1300 nanometer light in accordance with the present invention. The data using 1300 nm has similar trends as the 850 nm data but the 62.5 micron core diameter fiber appears to have poorer performance at high data rates than the 50 micron core fiber. However, the 100 micron core fiber again appears to perform as well as the equipment can measure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A system for high speed data transmission comprising:
a large core multimode fiber optic cable;
a light source for transmitting data; and
a lens having a focal length f for receiving light from said light source, said lens being approximately said focal length f from an exposed core of said large core multimode fiber optic cable wherein a light signal from said lens is focused on and has a diameter approximately equal to a core diameter of said large core multimode fiber optic cable to reduce excitation of higher order modes.

2. The system for high speed data transmission as recited in claim 1 wherein said lens collimates said light signal to reduce an excitation of higher order modes generated in said large core multimode fiber optic cable.

3. The system for high speed data transmission as recited in claim 1 wherein said light source is a diode laser.

4. The system for high speed data transmission as recited in claim 1 wherein light source is a light emitting diode.

5. The system for high speed data transmission as recited in claim 1 wherein said light source provides light having a wave length greater than 750 nanometers.

6. The system for high speed data transmission as recited in claim 1 wherein said light source transmits data at greater than 10 gigabits per second.

7. The system for high speed data transmission as recited in claim 1 wherein a signal level from said light source is launched to said large core multimode fiber optic cable at greater than 20 dBM.

8. The system for high speed data transmission as recited in claim 1 wherein a cladding layer around said core of said large core multimode fiber optic cable attenuates higher order modes to reduce pulse spreading effects that limit said length/data rate product.

9. The system for high speed data transmission as recited in claim 8 wherein a refractive index of said core is substantially real to propagate said light signal with low loss and wherein said refractive index of said cladding layer includes a complex component that attenuates higher order modes generated in said large core multimode fiber optic cable.

10. The system for high speed data transmission as recited in claim 1 further including a receiver coupled to an opposing end of said large core multimode fiber optic cable for receiving said transmitted data.

11. A method for increasing a length/data rate product for a large core multimode fiber optic cable comprising the steps of:
providing a data transmission comprising a sequence of light pulses;
collimating light of said data transmission to minimize excitation of higher order modes in the large core multimode fiber optic cable;
focusing said light pulses onto an exposed end of a core of the large core multimode fiber optic cable such that a diameter of a light pulse is approximately equal to a core diameter of the large core multimode fiber optic cable; and
attenuating higher order modes of said light pulses as said data transmission propagates down the large core multimode fiber optic cable.

12. The method for increasing a length/data rate product for a large core multimode fiber optic cable as recited in claim 11 further including using a lens to collimate and focus said light pulses to the large core multimode fiber optic cable.

13. The method of increasing a length/data rate product for a large core multimode fiber optic cable as recited in claim 11 further including a step of increasing a signal level of said data transmission to compensate for propagation loss thereby further increasing a transmission distance through the large core multimode fiber optic cable.

14. The method of increasing a length/data rate product for a large core multimode fiber optic cable as recited in claim 11 further including a step of using a core greater than 50 microns in diameter in the large core multimode fiber optic cable.

15. The method of increasing a length/data rate product for a large core multimode fiber optic cable as recited in claim 11 further including a step of using a step index fiber optic cable having a doped cladding layer for absorptive attenuation of higher order modes.

16. A method of increasing a length/data rate product of a large core multimode fiber optic cable comprising the steps of:
launching light signals to the large core multimode fiber optic cable to promote low order modes and reduce higher order modes; and
attenuating higher order modes as said light signals travel through the large core multimode fiber optic cable.

17. The method of increasing a length/data rate product of a large core multimode fiber optic cable as recited in claim 16 further including a step of operating the large core multimode fiber optic cable to transmit data at greater than 10 gigabits per second.

18. The method of increasing a length/data rate product of a large core multimode fiber optic cable as recited in claim 17 further including a step of using a step index large core multimode fiber optic cable.

19. The method of increasing a length/data rate product of a large core multimode fiber optic cable as recited in claim 16 further including the steps of:
collimating light of said light signals prior to launching said light signals to the large core multimode fiber optic cable; and
focusing light of said light signals to the large core multimode fiber optic cable having a diameter approximately equal to a diameter of a core of the large core multimode fiber optic cable.

20. The method of increasing a length/data rate product of a large core multimode fiber optic cable as recited in claim 19 wherein said step of attenuating higher order modes as said light signals travel through the large core multimode fiber optic cable further include a step of having the large core multimode fiber optic cable include a doped cladding layer for intentional absorption loss of higher order modes.
